(19) United States
(12) Patent Application Publication
(10) Pub. No.: US 2019/0283980 A1
(43) Pub. Date: Sep. 19, 2019

(54) TRANSFERRING SYSTEM AND METHOD OF OPERATING THE SAME

(71) Applicant: KAWASAKI JUKOGYO KABUSHIKI KAISHA, Kobe-shi, Hyogo (JP)

(72) Inventor: Satoru HIBINO, Kobe-shi (JP)

(73) Assignee: KAWASAKI JUKOGYO KABUSHIKI KAISHA, Kobe-shi, Hyogo (JP)

(21) Appl. No.: 16/463,101

(22) PCT Filed: Dec. 21, 2017
(86) PCT No.: PCT/JP2017/045966

§ 371 Date: May 22, 2019

(30) Foreign Application Priority Data
Dec. 22, 2016 (JP) 2016-249846

(51) Int. Cl. B65G 47/91; B65G 49/06; B25J 15/06

(52) U.S. Cl. CPC B65G 47/917; B25J 15/0616; B65G 49/06

(57) ABSTRACT

A transferring system includes a container where a plurality of sheet members are placed in a vertically-oriented fashion so that principal surfaces of the sheet members are inclined, a robot including an arm having a suction part, and a control device. The control device is configured to cause the suction part of the arm to suck the principal surface of the sheet member, and then operate the arm to move the sheet member in a direction at an angle of elevation other than a normal direction of the principal surface of the sheet member.

### TECHNICAL FIELD

The present disclosure relates to a transferring system and a method of operating the same.

### BACKGROUND ART

Substrate handling equipment is known as a device which transfers a large-sized substrate (for example, refer to Patent Document 1). In the substrate handling equipment disclosed in Patent Document 1, a plurality of substrates are accommodated in a vertical cassette so as to be separated from each other at a given interval, the vertical cassette is inclined by an inclining device, and a substrate hand is provided to hold the inclined substrate. The substrate hand includes a retainer plate extending along the substrate, movable support pawls which support a lower end of the substrate, and movable pinch pawls which pinch an upper end of the substrate.

Moreover, a vertically-mounting packing container is known, where a plurality of glass plates and inserting papers sandwiched between the glass plates are vertically mounted (for example, refer to Patent Document 2). In the packing container disclosed in Patent Document 2, an upper end face of a rear surface plate which receives one surface of the glass plate is formed as a slope surface which is higher as it goes from a receiving surface on the glass plate side toward a rear surface opposite from the receiving surface.

### REFERENCE DOCUMENT OF CONVENTIONAL ART

### Patent Documents

### [Patent Document 1] JP2002-19958A

### [Patent Document 2] JP2013-47110A

### DESCRIPTION OF THE DISCLOSURE

### Problems to be Solved by the Disclosure

However, in the packing container disclosed in Patent Document 2, it is described that a robotic arm having holes for vacuum suction or suction cups sucks and holds an external surface of the glass plate, and transfers it onto a transferring device, such as a conveyor. However, when transferring the glass plate by the robotic arm, there is a possibility that the inserting paper is transferred with the glass plate, while the inserting paper is adhered to the glass plate by the static force caused between the glass plate and the inserting paper. Therefore, there is still room for an improvement.

The present disclosure is made in view of solving the conventional problems, and purpose thereof is to provide a transferring system and a method of operating the same, which can easily transfer a sheet member one by one from a container where a plurality of sheet members are laminated in a vertically-oriented fashion.

### SUMMARY OF THE DISCLOSURE

In order to solve the conventional problem, a transferring system according to one aspect of the present disclosure includes a container where a plurality of sheet members are placed in a vertically-oriented fashion so that principal surfaces of the sheet members are inclined, a robot including an arm having a suction part, and a control device. The control device is configured to cause the suction part of the arm to suck the principal surface of the sheet member, and then operate the arm to move the sheet member in a direction at an angle of elevation other than a normal direction of the principal surface of the sheet member.

Thus, the sheet member can be easily transferred one by one from the container where the plurality of sheet members are laminated in the vertically-oriented fashion. Moreover, when conveying the sheet member, it can be prevented that the sheet member is rubbed by the adjacent sheet member, and it can be prevented that the surfaces of the sheet members are damaged.

A method of operating a transferring system according to another aspect of the present disclosure is a method of operating a transferring system provided with a container configured to accommodate sheet members in a vertically-oriented fashion so that principal surfaces of the sheet members are inclined, and a robot including an arm having a suction part. The method includes the steps of (A) operating the arm toward the principal surface of the sheet member, (B) causing the suction part of the arm to suck the principal surface of the sheet member after (A), and (C) operating the arm to move the sheet member in a direction that is a direction at an angle of elevation, of a first angle that is an angle formed by a horizontal surface and the principal surface of the sheet member, other than a normal direction of the principal surface of the sheet member, after (B).

Thus, the sheet member can be easily transferred one by one from the container where the plurality of sheet members are laminated in the vertically-oriented fashion. Moreover, when conveying the sheet member, it can be prevented that the sheet member is rubbed by the adjacent sheet member, and it can be prevented that the surfaces of the sheet members are damaged.

### Effect of the Discloser

According to the transferring system of the present disclosure and the method of operating the same, every one of the sheet members can be easily transferred from the container where the plurality of sheet members are laminated in the vertically-oriented fashion.

### BRIEF DESCRIPTION OF DRAWINGS

FIG. 1 is a schematic view illustrating an outline construction of a transferring system according to Embodiment 1.

FIG. 2 is a schematic view illustrating an outline construction of a robot in the transferring system illustrated in FIG. 1.

FIG. 3 is a functional block diagram schematically illustrating a configuration of a control device of the robot illustrated in FIG. 2.

FIG. 4 is a schematic view illustrating an outline construction of a right side surface of a first hand part in the robot illustrated in FIG. 2.

FIG. 5 is a block diagram illustrating one example of a control system of the transferring system (robot) according to Embodiment 1.

FIG. 6 is a flowchart illustrating one example of operation of the transferring system according to Embodiment 1.

FIG. 7 is a schematic view illustrating a state of the robot when the robot operates according to the flowchart illustrated in FIG. 6.

FIG. 8 is a schematic view illustrating a state of the robot when the robot operates according to the flowchart illustrated in FIG. 6.

FIG. 9 is a schematic view illustrating a state of the robot when the robot operates according to the flowchart illustrated in FIG. 6.

FIG. 10 is a schematic view illustrating an outline construction of a transferring system according to Embodiment 2.

FIG. 11 is a flowchart illustrating one example of operation of the transferring system according to Embodiment 2.

FIG. 12 is a schematic view illustrating an outline construction of a first hand part of the robot in a transferring system according to Embodiment 3.

FIG. 13 is a flowchart illustrating one example of operation of the transferring system according to Embodiment 3.

FIG. 14 is a schematic view illustrating an outline construction of a robot in a transferring system according to Embodiment 3.

FIG. 15 is a flowchart illustrating one example of operation of a transferring system according to Embodiment 4.

FIG. 16 is a flowchart illustrating one example of operation of a transferring system according to Embodiment 5.

### MODES FOR CARRYING OUT THE DISCLOSURE

Hereinafter, embodiments of the present disclosure will be described with reference to the drawings. Note that the same reference characters are given to the same or corresponding parts throughout the drawings to omit redundant description. Moreover, the components for illustrating the present disclosure are selectively illustrated throughout the drawings, and illustration of other components may be omitted. Further, the present disclosure is not limited to the following embodiments.

### Embodiment 1

A transferring system according to Embodiment 1 includes a container which accommodates sheet members placed on a vertically-standing fashion so that principal surfaces of the sheet members are inclined, a robot having an arm with a suction part, and a control device. The control device is configured to operate the arm so that, after a principal surface of one sheet member is sucked by the suction part of the arm, the sheet member moves in a direction which is a direction at an angle of elevation, of a first angle that is an angle formed by the horizontal surface and the principal surface of the sheet member, other than the normal direction of the principal surface of the sheet member.

Moreover, in the transferring system according to Embodiment 1, the suction part may be provided with a pressure detector, and the control device may operate the arm toward the principal surface of the sheet member, until the pressure detector detects a preset first pressure value.

Moreover, in the transferring system according to Embodiment 1, after the principal surface of the sheet member is sucked by the suction part of the arm, the control device may operate the arm so that the sheet member moves upwardly in the vertical direction.

Further, in the transferring system according to Embodiment 1, the robot may include a first arm having a first suction part, and a second arm having a second suction part.

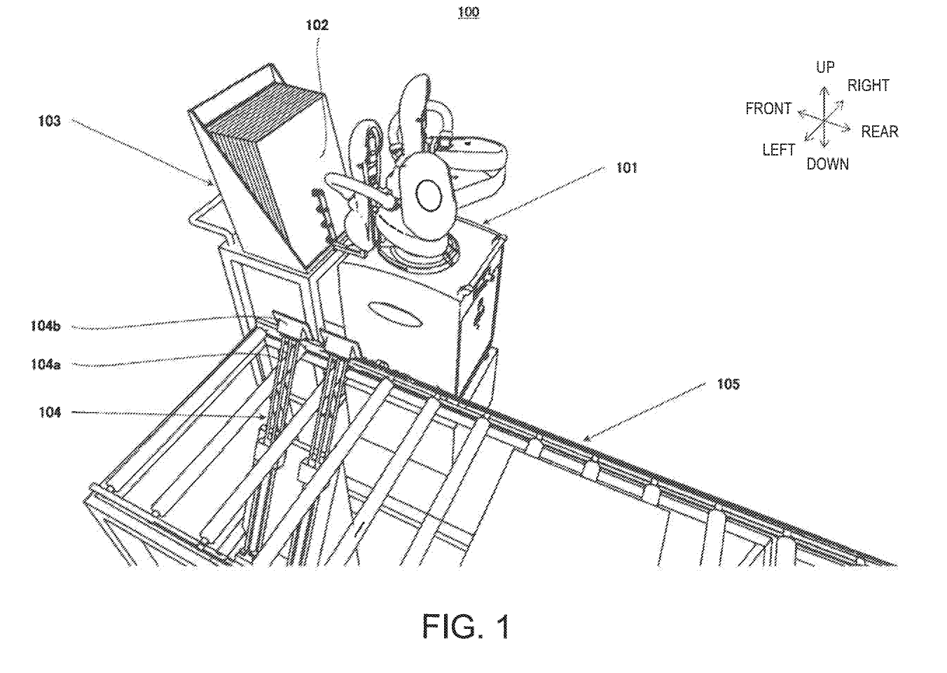

Hereinafter, one example of the transferring system according to Embodiment 1 is described with reference to FIGS. 1 to 8.

### [Configuration of Transferring System]

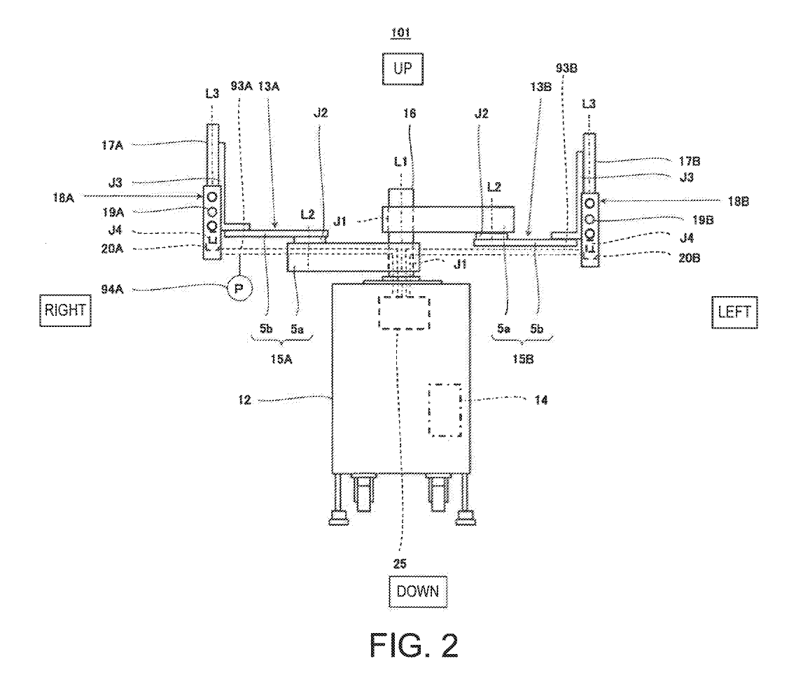

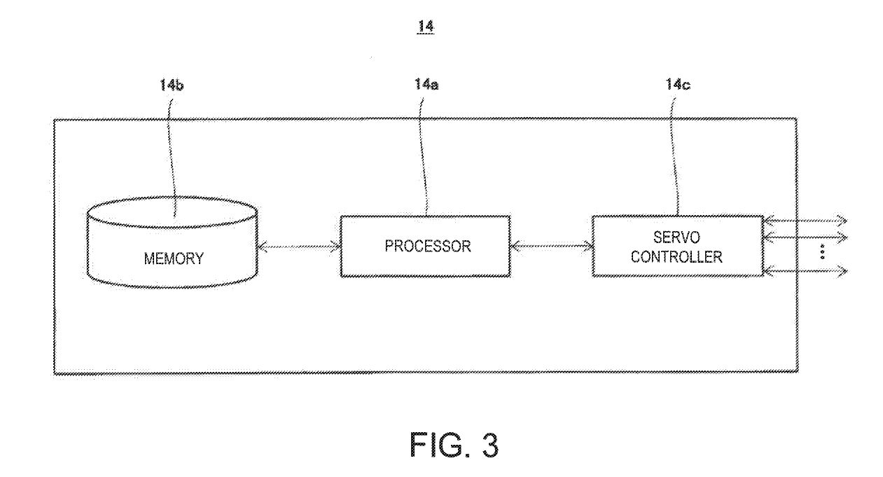

FIG. 1 is a schematic view illustrating an outline construction of the transferring system according to Embodiment 1. FIG. 2 is a schematic view illustrating an outline construction of the robot in the transferring system illustrated in FIG. 1. FIG. 3 is a functional block diagram schematically illustrating a configuration of the control device of the robot illustrated in FIG. 2.

Note that, in FIG. 1, a front-and-rear direction, an up-and-down direction, and a left-and-right direction of the robot are indicated as a front-and-rear direction, an up-and-down direction, and a left-and-right direction in this figure, respectively. Moreover, in FIG. 2, the up-and-down direction and the left-and-right direction of the robot are indicated as an up-and-down direction and a left-and-right direction in this figure, respectively.

As illustrated in FIG. 1, a transferring system 100 according to Embodiment 1 includes a robot 101, a container 103 which accommodates sheet members 102, and a belt conveyor 105. The robot 101 is configured to transfer the sheet member 102 accommodated in the container 103 onto the belt conveyor 105 through a placing device 104.

The container 103 is formed in a box shape, where the sheet members 102 are placed therein in a vertically-oriented fashion. Specifically, the sheet members 102 are each disposed so that the principal surface thereof contacts a rear surface of the container 103.

Moreover, the rear surface of the container 103 is formed so that it goes rearward of the robot 101 as it goes upward. That is, the container 103 is formed so that an angle formed by a bottom surface and the rear surface becomes an obtuse angle (an angle larger than 90° and smaller than 180°). Thus, the sheet members 102 can be placed on the container 103 so that the principal surfaces incline.

An upper surface and a front surface of the container 103 are opened, and a pair of side surfaces (left and right side surfaces) are each formed in a substantially triangular shape. Thus, the sheet member 102 placed on the vertically-oriented fashion becomes easier to be taken out.

The placing device 104 includes an arm part 104a and a holding part 104b. The placing device 104 is configured so that the sheet member 102 is placed on the holding part 104b, and the sheet member 102 is placed onto the belt conveyor 105 by retracting the arm part 104a downwardly.

The belt conveyor 105 is disposed at one side of the robot 101 (here, the left side), and is configured to send rearwardly the sheet member 102 which is disposed by the robot 101 on the upper surface of the belt conveyor 105.

Next, a concrete structure of the robot 101 is described with reference to FIG. 2. Note that, although a horizontal articulated dual-arm robot is described as the robot 101 in the following description, other robots of horizontal articulated or vertical articulated type may also be adopted as the robot 101.

As illustrated in FIG. 2, the robot 101 includes a carrier 12, a first arm 13A, a second arm 13B, a vacuum generator 25, and a control device 14. the control device 14 is configured to control the first arm 13A, the second arm 13B, and the vacuum generator 25. Note that, in Embodiment 1, although the form in which the control device 14 and the vacuum generator 25 are disposed inside the carrier 12 is adopted, these apparatuses may be disposed outside the carrier 12, without being limited to the structure.

A base shaft 16 is fixed to an upper surface of the carrier 12. The base shaft 16 is provided with the first arm 13A and the second arm 13B so as to be rotatable about a rotation axis L1 passing through the axial center of the base shaft 16. Specifically, the first arm 13A and the second arm 13B are provided so as to have a height difference therebetween. Further, the control device 14 and the vacuum generator 25 are accommodated inside the carrier 12. Note that the first arm 13A and the second arm 13B are configured so as to operate independently or operate dependently.

The first arm 13A includes a first arm part 15A, a first wrist part (link member) 17A, a first hand part 18A, and a first attaching part 20A. Similarly, the second arm 13B includes a second arm part 15B, a second wrist part (link member) 17B, a second hand part 18B, and a second attaching part 20B. Note that, since the second arm 13B is constructed similarly to the first arm 13A, the detailed description thereof is omitted herein.

In Embodiment 1, the first arm part 15A is comprised of a first link member 5a and a second link member 5b each of which are of a substantially rectangular parallelepiped shape. The first link member 5a is provided at a base-end part with a rotary joint J1, and is provided at a tip-end part with a rotary joint J2. Moreover, the second link member 5b is provided at a tip-end part with a linear-motion joint J3.

The first link member 5a is coupled at the base-end part to the base shaft 16 through the rotary joint J1, and can be rotated about the rotation axis L1 by the rotary joint J1. Moreover, the second link member 5b is coupled at a base-end part to the tip-end part of the first link member 5a through the rotary joint J2, and can be rotated about a rotation axis L2 by the rotary joint J2.

The first wrist part 17A is coupled to the tip-end part of the second link member 5b through the linear-motion joint J3 so as to be ascendable and descendable with respect to the second link member 5b. A rotary joint J4 is provided to a lower end part of the first wrist part 17A, and the first attaching part 20A is provided to a lower end part of the rotary joint J4.

The first attaching part 20A is constructed so that the first hand part 18A is attachable and detachable. Specifically, for example, the first attaching part 20A has a pair of bar members so that an interval therebetween can be adjusted, and the first hand part 18A can be attached to the first wrist part 17A by pinching the first hand part 18A by the pair of bar members. Thus, the first hand part 18A can be rotated about a rotation axis L3 by the rotary joint J4. Note that a tip-end portion of each bar member may be bent or curved.

Moreover, the first to fourth joints JT1-JT4 of the first arm 13A and the second arm 13B are provided with drive motors M1-M4 as one example of actuators, each relatively rotates two link members coupled by the corresponding joint. The drive motors M1-M4 may be, for example, servo motors which are servo-controlled by the control device 14.

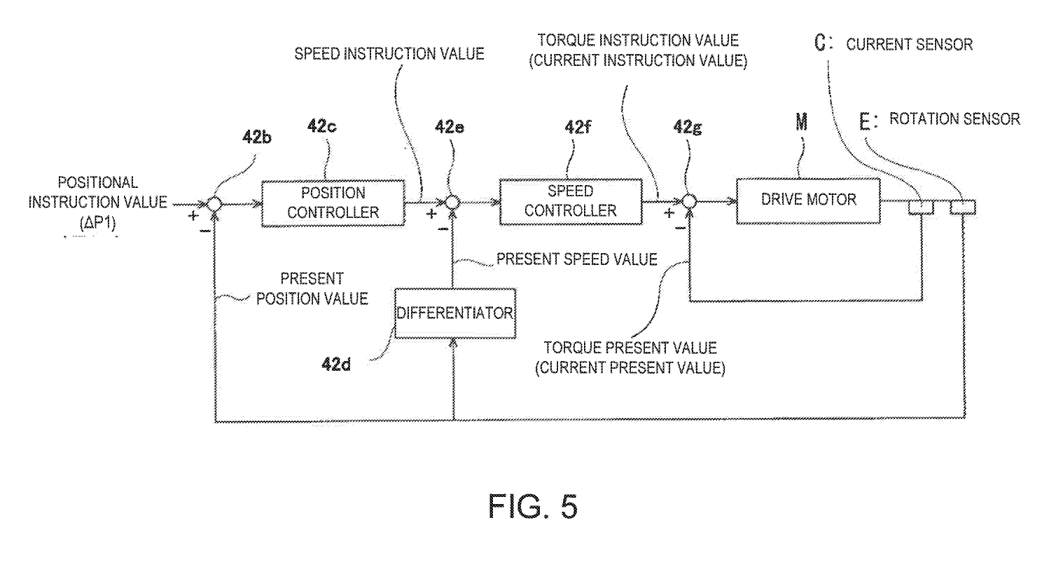

Moreover, the first to fourth joints JT1-JT4 are provided with rotation sensors (rotation detectors) E1-E4 (refer to FIG. 5) which detect the rotational positions (rotation angle values; present position values) of the drive motors M1-M4, and current sensors (current detectors) C1-C4 (refer to FIG. 5) which detect current which controls the rotation of the drive motors M1-M4, respectively. The rotation sensors E1-E4 may be, for example, encoders.

Note that, in the description of the drive motors M1-M4, the rotation sensors E1-E4, and the current sensors C1-C4, a suffix of 1 to 4 are given to the alphabet corresponding to the first to fourth joints JT1-JT4. In the following, when an arbitrary joint among the first to fourth joints JT1-JT4 is illustrated, the subscript is omitted and the corresponding joint is referred to as the “joint JT.” The drive motor M, the rotation sensor E, and the current sensor C are treated similarly.

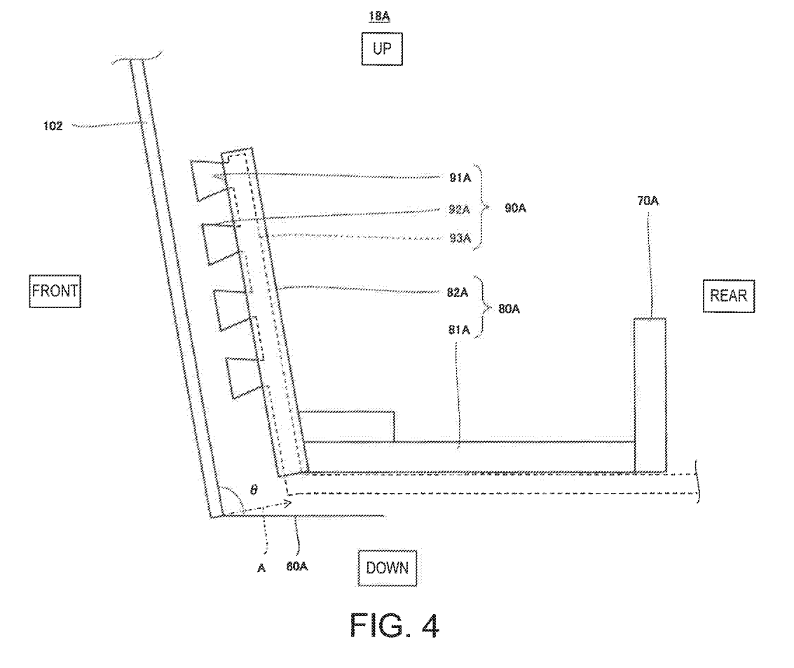

Here, with reference to FIGS. 2 and 4, the first hand part 18A of the first arm 13A is described in detail.

FIG. 4 is a schematic view illustrating an outline construction of a right side surface of the first hand part in the robot illustrated in FIG. 2. Note that, in FIG. 4, the up-and-down direction and the front-and-rear direction of the robot are indicated as an up-and-down direction and a front-and-rear direction in this figure, respectively.

As illustrated in FIGS. 2 and 4, the first hand part 18A of the first arm 13A is comprised of a stationary part 70A, a main body 80A, and a first suction part 90A. The stationary part 70A is a part where the first attaching part 20A contacts, and is formed here in a cylindrical shape.

The main body 80A is formed in a substantially L-shape, and has a first portion 81A extending horizontally and a second portion 82A extending in the up-and-down direction. The second portion 82A may be formed so as to become parallel to an inclination angle θ of the sheet member 102. Moreover, the second portion 82A may be configured so that the inclination angle is arbitrarily changeable.

Here, the inclination angle θ of the sheet member 102 is an angle formed by a horizontal surface 60A and the principal surface of the sheet member 102 when a rear side of the robot 101 is 0° and a front side of the robot 101 is 180°.

Moreover, one or more (here, four) openings 91A are formed in a front surface of the second portion 82A, and a truncated-cone-shaped suction pad 92A is provided to each opening 91A. Moreover, the openings 91A are connected to the vacuum generator 25 through the first piping 93A (refer to FIG. 2). Note that the opening(s) 91A, the suction pad(s) 92A, and the first piping 93A constitute the first suction part 90A.

The vacuum generator 25 is device which evacuates the inside of the first suction part 90A to a negative pressure, and may be, for example, a vacuum pump or CONVUM®. An on-off valve (not illustrated) is provided to the first piping 93A. When the on-off valve opens or closes the first piping 93A, suction and release of the sheet member 102 are performed by the suction pads 92A. Note that the operation of the vacuum generator 25 and the opening and closing of the on-off valve are controlled by the control device 14.

As illustrated in FIG. 2, a pressure detector 94A is provided at a suitable location of the first suction part 90A. The pressure detector 94A is configured to detect a pressure inside the first suction part 90A and output the detected pressure to the control device 14. Note that, although the form in which the pressure detector is provided to the first suction part 90A is adopted in Embodiment 1, a form in which the pressure detector is provided to a second suction part 90B may be adopted, or a form in which the pressure detector is provided to each of the first suction part 90A and the second suction part 90B may be adopted, without being limited to the above structure.

As illustrated in FIG. 3, the control device 14 includes a processor 14a, such as a CPU, a memory 14b, such as a ROM and/or a RAM, and a servo controller 14c. The control device 14 is, for example, a robot controller provided with a calculator, such as a microcontroller.

Note that the control device 14 may be comprised of a sole control device 14 which carries out a centralized control, or may be comprised of a plurality of control devices 14 which collaboratively carry out a distributed control. Moreover, in Embodiment 1, although the form in which the memory 14b is provided inside the control device 14 is adopted, a form in which the memory 14b is disposed separately from the control device 14 may be adopted, without being limited to the above structure.

The memory 14b stores information on a basic program as the robot controller, various fixed data, etc. The processor 14a controls various operations of the robot 101 by reading and executing software, such as the basic program stored in the memory 14b. That is, the processor 14a generates a control command of the robot 101, and then outputs it to the servo controller 14c. The servo controller 14c is configured to control the drive of the servo motors corresponding to the respective joints J1-J4 of the first arm 13A and the second arm 13B of the robot 101 based on the control command generated by the processor 14a.

### [Operation of Transferring System]

Next, operation of the transferring system 100 according to Embodiment 1 is described with reference to FIGS. 1 to 9. Note that, the following operation is performed by the processor 14a of the control device 14 reading the program stored in the memory 14b.

First, a flow of signals when the robot 101 in the transferring system 100 according to Embodiment 1 is automatically operated is described with reference to FIG. 5.

FIG. 5 is a block diagram illustrating one example of a control system of the transferring system (robot) according to Embodiment 1.

As illustrated in FIG. 5, when operating the robot 101 automatically, the control device 14 reads a task program and controls the rotational position of the drive motor M of the robot 101 based on an operating command value (ΔP1) of the robot. Note that, in the following, the operating command value (ΔP1) of the robot 101 is assumed to be a path instruction value (positional instruction value) including time series data.

A subtractor 42b subtracts the present position value detected by the rotation sensor E from the inputted positional instruction value to generate an angle difference. The subtractor 42b outputs the generated angle difference to a position controller 42c.

The position controller 42c generates a speed instruction value based on the angle difference inputted from the subtractor 42b by a calculation processing based on a preset transfer function or a proportional coefficient. The position controller 42c outputs the generated speed instruction value to a subtractor 42e.

A differentiator 42d differentiates the present position value information detected by the rotation sensor E to generate an amount of change per unit time of the rotation angle of the drive motor M, i.e., the present speed value. The differentiator 42d outputs the generated present speed value to the subtractor 42e.

The subtractor 42e subtracts the present speed value inputted from the differentiator 42d from the speed instruction value inputted from the position controller 42c to generate a speed difference. The subtractor 42e outputs the generated speed difference to a speed controller 42f.

The speed controller 42f generates a torque instruction value (current instruction value) based on the speed difference inputted from the subtractor 42e by a calculation processing based on a preset transfer function or a proportional coefficient. The speed controller 42f outputs the generated torque instruction value to a subtractor 42g.

The subtractor 42g subtracts the current present value detected by the current sensor C from the torque instruction value inputted from the speed controller 42f to generate a current difference. The subtractor 42g outputs the generated current difference to the drive motor M to drive the drive motor M.

Note that, in Embodiment 1, although the form in which the operating command value (ΔP1) of the robot is the path instruction value (positional instruction value) including the time series data is adopted, it is not limited to this configuration. For example, a form in which ΔP1 is the speed instruction value may be adopted, or a form in which ΔP1 is a torque instruction value may be adopted.

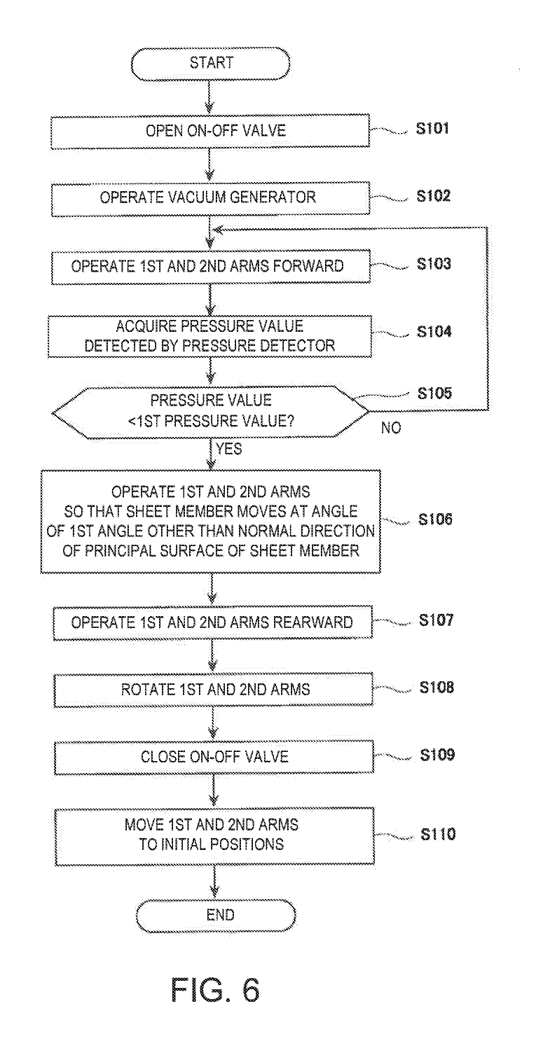

Next, transferring operation of the sheet member 102 by the transferring system 100 according to Embodiment 1 is described with reference to FIGS. 6 to 9.

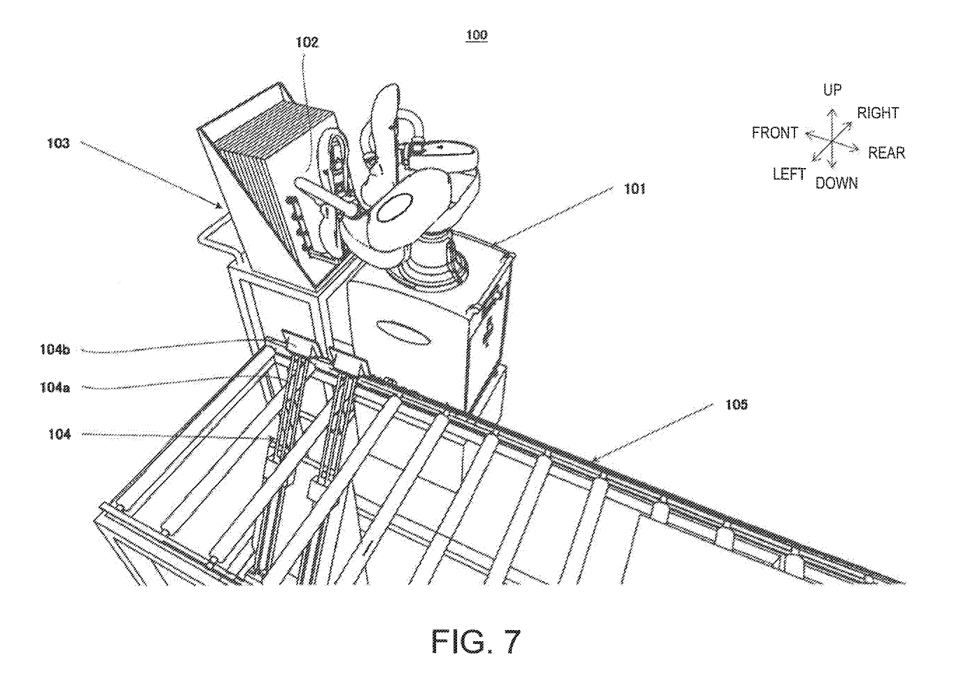

FIG. 6 is a flowchart illustrating one example of operation of the transferring system according to Embodiment 1. FIGS. 7 to 9 are schematic views illustrating states of the robot when the robot operates according to the flowchart illustrated in FIG. 6.

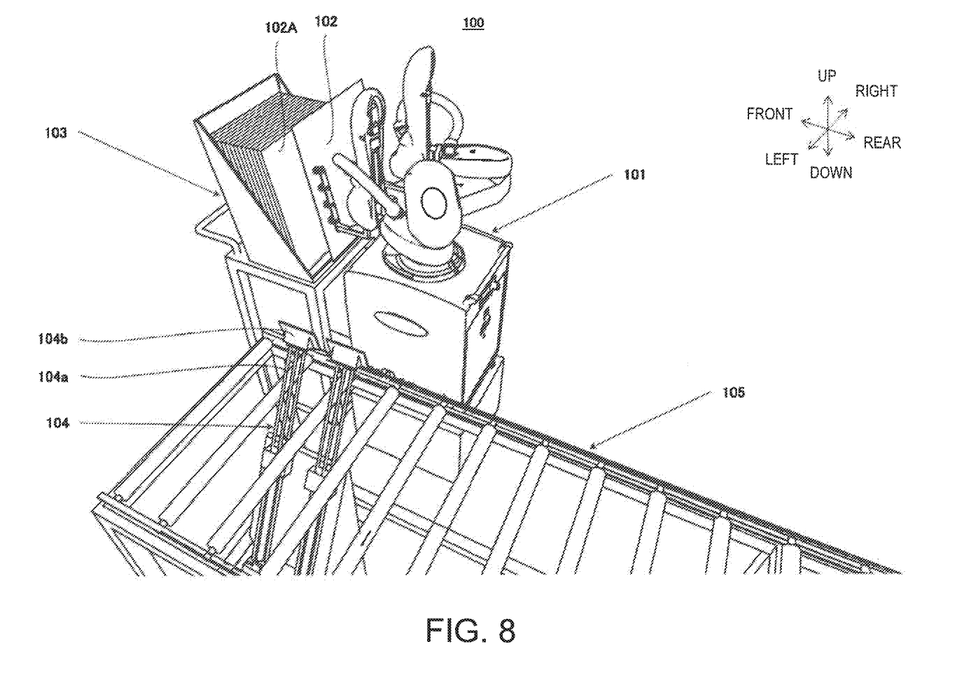

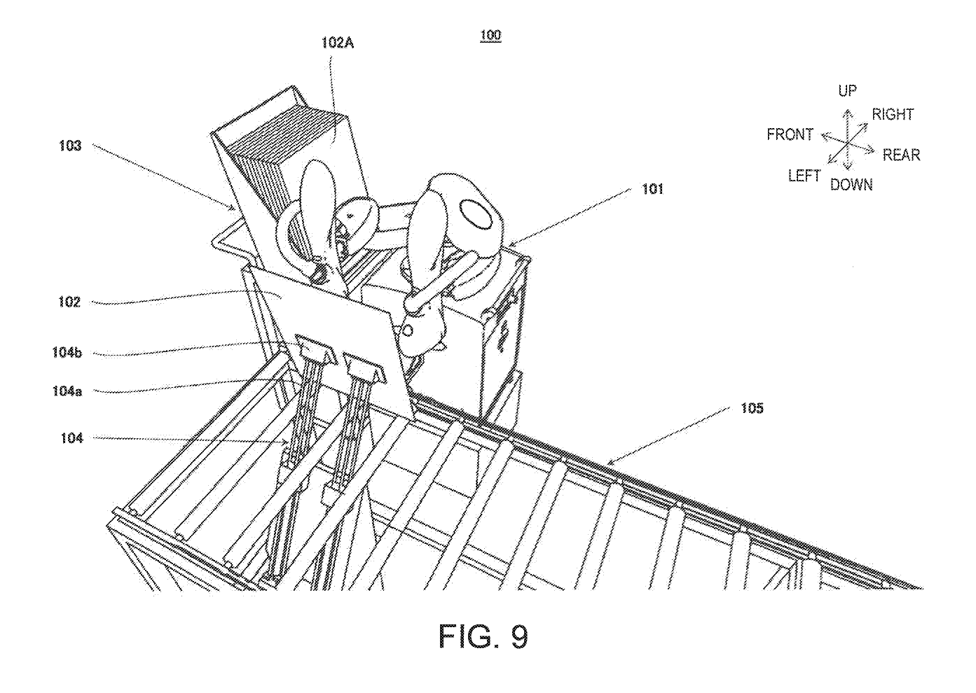

Specifically, FIG. 7 is a perspective view illustrating a state where the first arm and the second arm contact the sheet member (a state where the sheet member is sucked by the suction part). FIG. 8 is a perspective view illustrating a state where, the first arm and the second arm are operated upwardly in the vertical direction while sucking the sheet member by the suction part, and the first arm and the second arm are then operated horizontally (rearward). FIG. 9 is a perspective view illustrating a state where the first arm and the second arm are rotated counterclockwise and place the sheet member on the placing device.

First, as illustrated in FIG. 1, the container 103 which accommodates the sheet members 102 is disposed in front of the robot 101, and the belt conveyor 105 is disposed at the side of the robot 101. Then, an operator inputs to the control device 14 through an input device (not illustrated), an instruction information indicating that operation of taking out the sheet member 102 accommodated in the container 103, and placing the sheet member 102 onto the belt conveyor 105 is to be executed.

Then, as illustrated in FIG. 6, the control device 14 opens the on-off valve (not illustrated) provided at the suitable location of the first suction part 90A (Step S101), and operates the vacuum generator 25 (Step S102).

Next, the control device 14 operates the first arm 13A and the second arm 13B forward (Step S103), and acquires the pressure value detected by the pressure detector 94A (Step S104). Next, the control device 14 determines whether the pressure value acquired at Step S104 is below a first pressure value (Step S105).

Here, the first pressure value can be set beforehand by an experiment etc. Specifically, for example, the vacuum generator 25 is operated while the on-off valve is opened, and the suction pad 92A and a suction pad 92B are brought into contact with the principal surface of the sheet member 102. In this state, the pressure value which is detected by the pressure detector 94A may be used as the first pressure value. Moreover, for example, the first pressure value may be −70 kPa to −90 kPa.

If the control device 14 determines that the pressure value acquired at Step S104 is higher than the first pressure value (No at Step S105), it returns to Step S103, and repeats Steps S103-S105 until the pressure value acquired at Step S104 becomes below the first pressure value.

On the other hand, if the control device 14 determines that the pressure value acquired at Step S104 is below the first pressure value (Yes at Step S105), it transits to processing at Step S106 because the suction pad 92A and the suction pad 92B contact the principal surface of the sheet member 102, and suck the principal surface of the sheet member 102 (refer to FIG. 7).

At Step S106, the control device 14 operates the first arm 13A and the second arm 13B so that the sheet member 102 moves in a direction at an angle of elevation, other than a normal direction A of the principal surface of the sheet member 102 (refer to FIG. 4).

In more detail, the control device 14 operates the first arm 13A and the second arm 13B so that the sheet member 102 moves in a direction in which one sheet member 102 is separated from another sheet member 102A which is adjacent thereto (refer to FIG. 8), other than the normal direction A of the principal surface of the sheet member 102 and a direction at an angle parallel to the principal surface of the sheet member 102. Specifically, in Embodiment 1, the control device 14 operates the first arm 13A and the second arm 13B so as to move upwardly in the vertical direction by a given distance (refer to FIG. 8).

Thus, it can be prevented that one sheet member 102A which is adjacent to another sheet member 102 to be transferred is adhered to the sheet member 102 due to the static force caused between the adjacent sheet members 102 and 102, and is transferred together by the robot 101.

Moreover, when moving the sheet member 102, it can be prevented that the sheet member 102 is rubbed by the sheet member 102A, and the surfaces of the sheet members 102 and 102A are damaged.

Note that the distance by which the first arm 13A and the second arm 13B move upwardly is suitably set based on the size of the sheet member 102 (the length in the up-and-down direction), the lengths of the first wrist part 17A and the second wrist part 17B, and the lengths of the second portion 82A and a second portion 82B.

Next, the control device 14 operates the first arm 13A and the second arm 13B so as to move rearwardly (Step S107), and then rotate them in the counterclockwise direction (Step S108; refer to FIG. 9). Next, the control device 14 closes the on-off valve (Step S109).

Thus, the first arm 13A and the second arm 13B can cancel the suction and hold of the sheet member 102, and can bring the principal surface of the sheet member 102 in contact with the holding part 104b. When the sheet member 102 is placed on the holding part 104b, the placing device 104 moves the arm part 104a downwardly and places the sheet member 102 onto the belt conveyor 105.

Next, the control device 14 operates the first arm 13A and the second arm 13B to be located at a given preset position (initial position) (Step S110), and ends this program.

Note that the control device 14 may control the operation of the placing device 104. Moreover, the control device 14 repeats this program, and when all the sheet members 102 accommodated in the container 103 are transferred, it may output information (for example, an image, sound, light, etc.) indicating that the transfer is finished.

### [Operation and Effects of Transferring System]

Meanwhile, when the sheet member 102 is moved in the normal direction of the principal surface of the sheet member 102 by the first arm 13A and the second arm 13B, there is a possibility that, due to the static force caused between the adjacent sheet members 102 and 102, the sheet member 102A which is adjacent to the sheet member 102 to be transferred is adhered to the sheet member 102, and is transferred together by the robot 101.

However, in the transferring system 100 according to Embodiment 1, the control device 14 operates the first arm 13A and the second arm 13B so that the sheet member 102 moves in the direction at the angle of elevation, other than the normal direction A of the principal surface of the sheet member 102. That is, the control device 14 operates the first arm 13A and the second arm 13B so that the sheet member 102 moves in the direction in which the sheet member 102 is separated from the adjacent sheet member 102A, other than the normal direction A of the principal surface of the sheet member 102 and the direction at an angle parallel to the principal surface of the sheet member 102.

Thus, the sheet member 102 can be easily transferred one by one from the container 103 where the plurality of sheet members 102 are laminated in the vertically-oriented fashion. Moreover, when conveying the sheet member 102, it can be prevented that the sheet member 102 is rubbed by the adjacent sheet member 102A, and it can be prevented that the surfaces of the sheet members 102 and 102A are damaged.

### Embodiment 2

In the transferring system according to Embodiment 1, the transferring system according to Embodiment 2 includes a residual quantity detector which is provided to the container and detects a residual quantity of the sheet members. The control device is configured to set an operating amount by which the arm is operated toward the principal surface of the sheet member based on the residual quantity of the sheet members detected by the residual quantity detector.

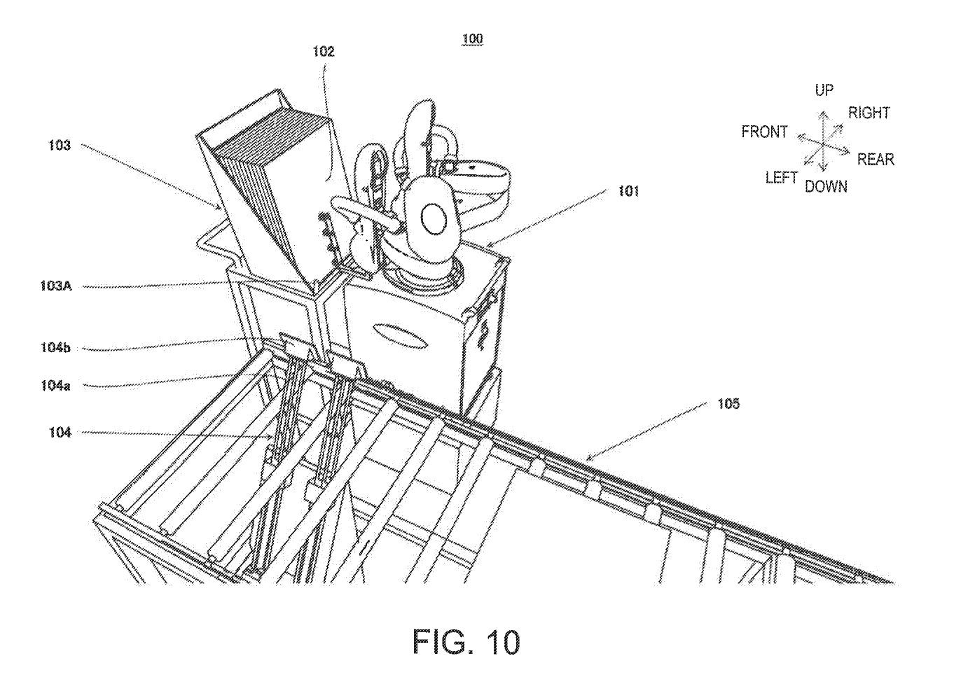

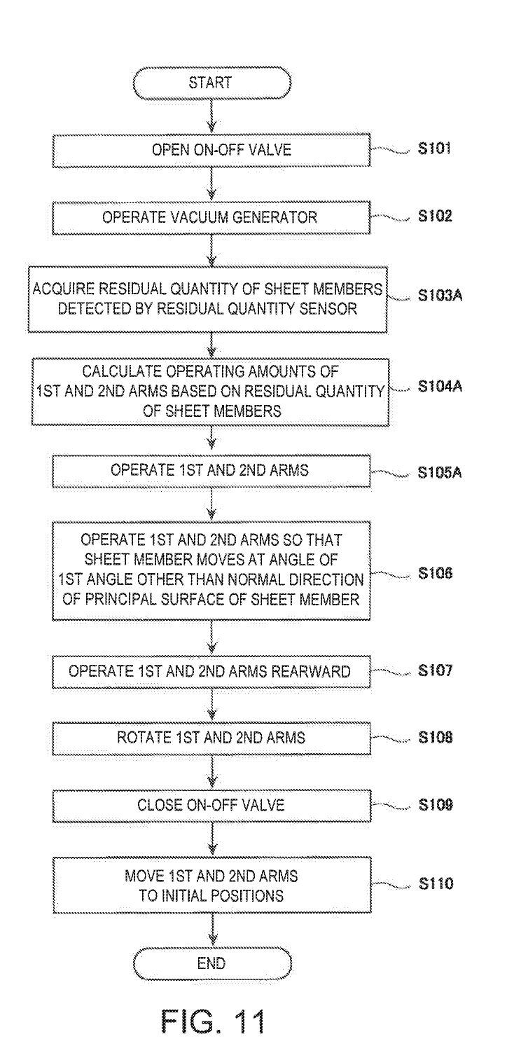

Below, one example of the transferring system according to Embodiment 2 is described with reference to FIGS. 10 and 11.

### [Configuration of Transferring System]

FIG. 10 is a schematic view illustrating an outline construction of the transferring system according to Embodiment 2. Note that, in FIG. 10, the front-and-rear direction, the up-and-down direction, and the left-and-right direction of the robot are indicated as a front-and-rear direction, an up-and-down direction, and a left-and-right direction in this figure, respectively.

As illustrated in FIG. 10, the transferring system 100 according to Embodiment 2 is fundamentally the same in the configuration as the transferring system 100 according to Embodiment 1, but it differs in that a residual quantity sensor 103A is provided to the container 103. The residual quantity sensor 103A is configured to detect the residual quantity of the sheet members 102 disposed in the container 103, and output the detected residual quantity to the control device 14. As the residual quantity sensor 103A, a known residual quantity sensor (a sensor having a variable resistor) may be used.

Note that, in the transferring system 100 according to Embodiment 2, the pressure detector 94A may be or may not be provided to the robot 101.

### [Operation and Effects of Transferring System]

Next, operation and effects of the transferring system 100 according to Embodiment 2 are described with reference to FIGS. 10 and 11. Note that the following operation is performed by the processor 14a of the control device 14 reading the program stored in the memory 14b.

FIG. 11 is a flowchart illustrating one example of operation of the transferring system according to Embodiment 2.

As illustrated in FIG. 11, although the operation of the transferring system 100 according to Embodiment 2 is performed fundamentally similarly to the operation of the transferring system 100 according to Embodiment 1, it differs in that Steps S103A-S105A are executed, in stead of Steps S103-S105.

Specifically, the control device 14 acquires the residual quantity of the sheet members 102 in the container 103 detected by the residual quantity sensor 103A (Step S103A). Next, the control device 14 calculates the operating amounts of the first arm 13A and the second arm 13B based on the residual quantity of the sheet members 102 acquired at Step S103A (Step S104A).

In more detail, the control device 14 calculates directions in which the first arm 13A and the second arm 13B are to be operated, and amounts of change in the operations. The control device 14 may calculate, for example, respective rotation angles of the drive motors M1-M4 disposed at the respective joints J1-J4 of the first arm 13A and the second arm 13B. Moreover, the control device 14 may calculate, for example, amounts of output of current (current value) for operating the respective drive motors M1-M4.

Next, the control device 14 operates the first arm 13A and the second arm 13B based on the operating amounts calculated at Step S104A (Step S105A). Specifically, the control device 14 may operate the first arm 13A and the second arm 13B located at the initial positions, for example, so as to move forward by the distance until the suction pad 92A and the suction pad 92B contact the principal surface of the sheet member 102.

Next, similar to the transferring system 100 according to Embodiment 1, the control device 14 executes the processings at Steps S106-S110, and transfers the sheet member 102 onto the belt conveyor 105 by the first arm 13A and the second arm 13B.

The transferring system 100 according to Embodiment 2 configured in this way also has similar operation and effects to the transferring system 100 according to Embodiment 1.

Moreover, in the transferring system 100 according to Embodiment 2, since the operating amounts of the first arm 13A and the second arm 13B are set based on the residual quantity of the sheet members 102 in the container 103 detected by the residual quantity sensor 103A, the suction pad 92A and the suction pad 92B can be brought in contact with the principal surface of the sheet member 102 more accurately, as compared with the transferring system 100 according to Embodiment 1.

Note that, although the form in which the operating amounts of the first arm 13A and the second arm 13B are set based on the residual quantity of the sheet members 102 detected by the residual quantity sensor 103A is adopted in the transferring system 100 according to Embodiment 2, it is not limited to this configuration. For example, the control device 14 may acquire image information which is imaged by an imaging device, and acquire positional information on the sheet member 102 accommodated in the container 103 from the acquired image information, and set the operating amounts of the first arm 13A and the second arm 13B based on the positional information.

### Embodiment 3

In the transferring system according to Embodiment 1 or 2, the transferring system according to Embodiment 3 includes a contact detector provided to the arm, and the control device is configured to operate the arm toward the principal surface of the sheet member, until the contact detector detects a contact with the principal surface of the sheet member.

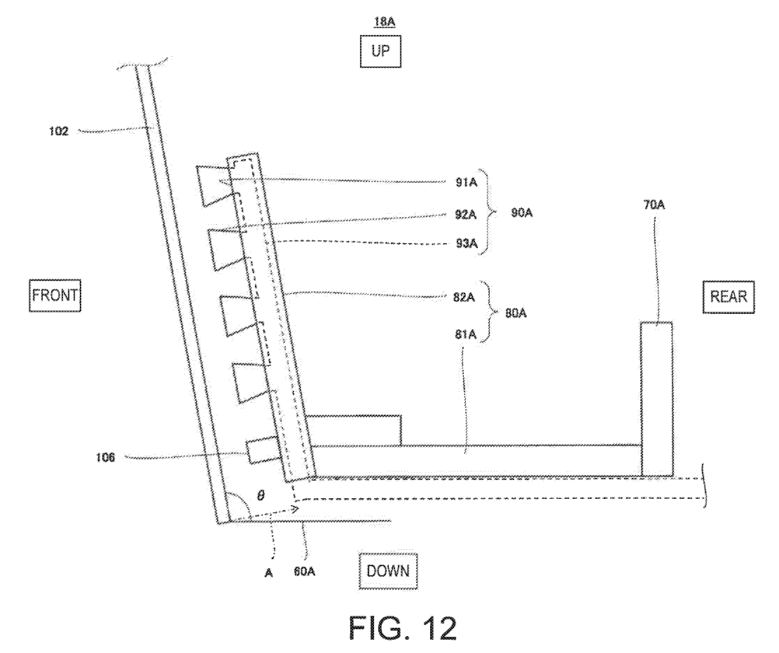

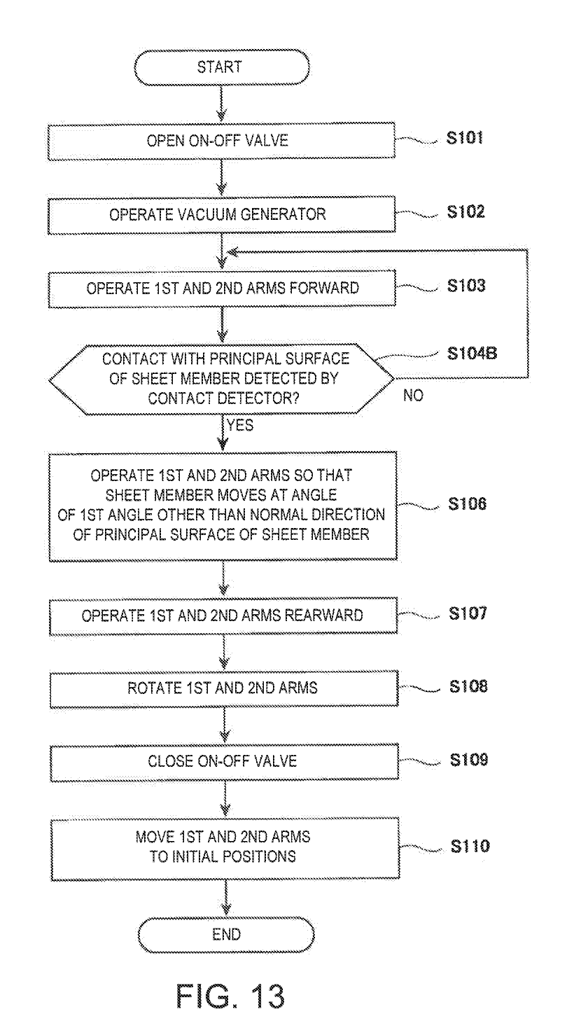

Below, one example of the transferring system according to Embodiment 3 is described with reference to FIGS. 12 and 13.

### [Configuration of Transferring System]

FIG. 12 is a schematic view illustrating an outline construction of a first hand part of the robot in the transferring system according to Embodiment 3. Note that, in FIG. 12, the up-and-down direction and the front-and-rear direction of the robot are indicated as an up-and-down direction and a front-and-rear direction in this figure, respectively.

As illustrated in FIG. 12, although the transferring system 100 according to Embodiment 3 is fundamentally the same in the structure as the transferring system 100 according to Embodiment 1, it differs in that a contact detector 106 is provided to the first arm 13A of the robot 101.

The contact detector 106 is disposed so as to detect, when the suction pad 92A contacts the principal surface of the sheet member 102, the contact with the principal surface of the sheet member 102. Specifically, in Embodiment 3, the contact detector 106 is disposed at a tip-end part (main body 80A) of the first hand part 18A of the first arm 13A.

Moreover, the contact detector 106 is configured to output to the control device 14 a signal (information) indicative of the contact, when contacted with the principal surface of the sheet member 102. Note that a known contact detector may be used as the contact detector 106.

### [Operation and Effects of Transferring System]

Next, operation and effects of the transferring system 100 according to Embodiment 3 are described with reference to FIGS. 12 and 13. Note that the following operation is performed by the processor 14a of the control device 14 reading the program stored in the memory 14b.

FIG. 13 is a flowchart illustrating one example of the operation of the transferring system according to Embodiment 3.

As illustrated in FIG. 13, although the operation of the transferring system 100 according to Embodiment 3 is fundamentally the same as the operation of the transferring system 100 according to Embodiment 1, it differs in that Step S104B is executed, instead of Steps S104 and S105.

Specifically, the control device 14 operates the first arm 13A and the second arm 13B forward (Step S103), and determines whether the contact detector 106 detects the contact with the principal surface of the sheet member 102 (Step S104B).

If the control device 14 determines that the contact detector 106 has not detected the contact with the principal surface of the sheet member 102 (No at Step S104B), it returns to Step S103 and repeats Steps S103 and S104 until the contact detector 106 detects the contact with the principal surface of the sheet member 102.

On the other hand, if the control device 14 determines that the contact detector 106 detects the contact with the principal surface of the sheet member 102 (Yes at Step S104B), it can determine that the suction pad 92A and the suction pad 92B contact the principal surface of the sheet member 102, and the sheet member 102 is sucked by the suction pad 92A and the suction pad 92B. Thus, the control device 14 transits to processing at Step S106.

Subsequently, the control device 14 executes the processings at Steps S106-S110, similar to the transferring system 100 according to Embodiment 1.

The transferring system 100 according to Embodiment 3 configured in this way also has similar operation and effects to the transferring system 100 according to Embodiment 1.

### Embodiment 4

In the transferring system of any one of Embodiments 1 to 3, a robot of the transferring system according to Embodiment 4 further includes a drive motor which relatively drives two link members connected through a joint, and a rotation detector which detects a rotation angle of the drive motor, and the control device is configured to operate the arm toward the principal surface of the sheet member, until a difference between a rotation angle instruction value to the drive motor and a rotation angle value detected by the rotation detector becomes larger than a given preset first value.

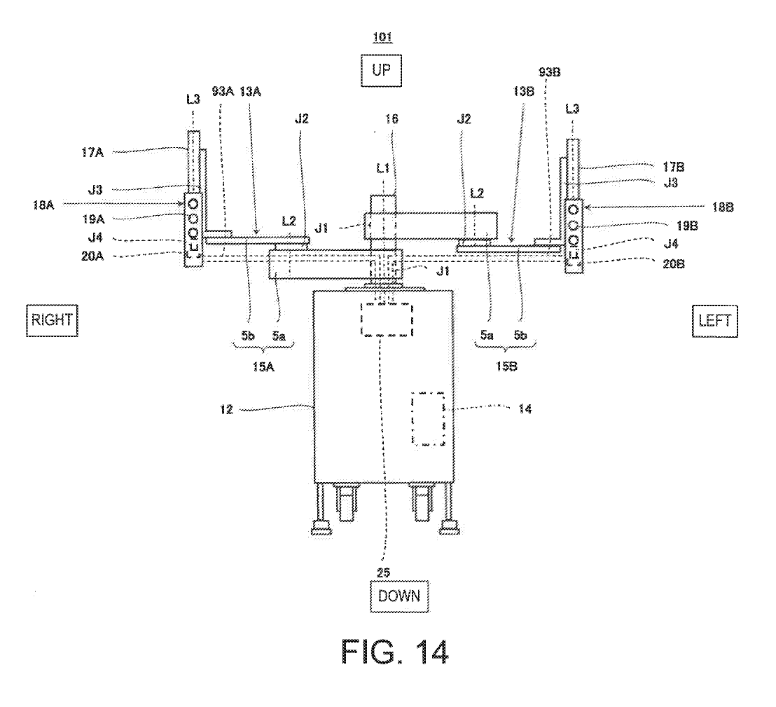

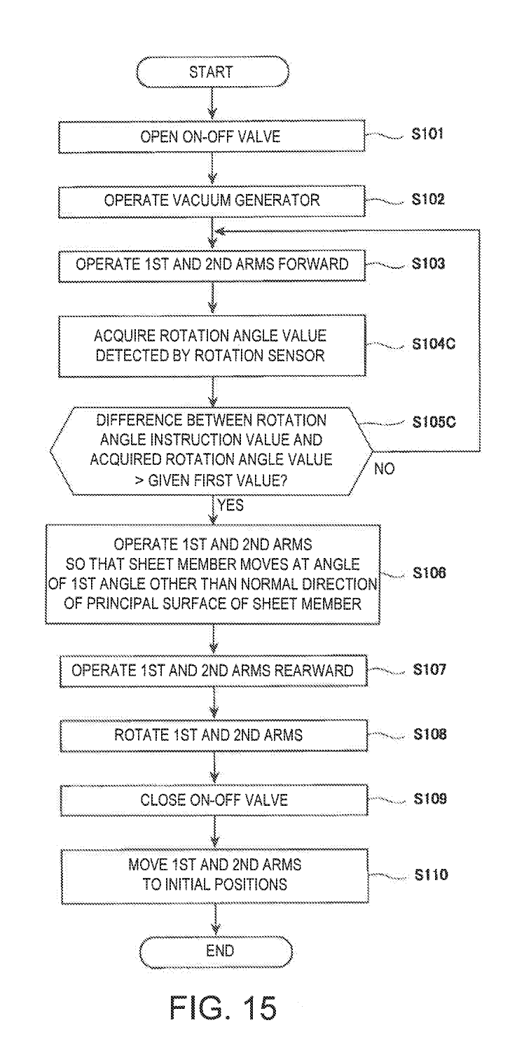

Below, one example of the transferring system according to Embodiment 4 is described with reference to FIGS. 14 and 15.

### [Configuration of Transferring System]

FIG. 14 is a schematic view illustrating an outline construction of the robot in the transferring system according to Embodiment 3. Note that, in FIG. 14, the up-and-down direction and the left-and-right direction of the robot are indicated as an up-and-down direction and the left-and-right direction in this figure, respectively.

As illustrated in FIG. 14, although the transferring system 100 according to Embodiment 4 is fundamentally the same in the configuration as the transferring system 100 according to Embodiment 1, it differs in that the pressure detector 94A is not provided to the first suction part 90A of the robot 101. Note that, in Embodiment 4, although the form in which the pressure detector 94A is not provided is adopted, it is not limited to this configuration, and a form in which the pressure detector 94A is provided similar to the transferring system 100 according to Embodiment 1 may be adopted.

### [Operation and Effects of Transferring System]

Next, operation and effects of the transferring system 100 according to Embodiment 4 are described with reference to FIGS. 14 and 15. Note that the following operation is performed by the processor 14a of the control device 14 reading the program stored in the memory 14b.

FIG. 15 is a flowchart illustrating one example of operation of the transferring system according to Embodiment 4.

As illustrated in FIG. 15, although the operation of the transferring system 100 according to Embodiment 4 is fundamentally the same as the operation of the transferring system 100 according to Embodiment 1, it differs in that Steps S104C and S105C are executed, instead of Steps S104 and S105.

Specifically, the control device 14 operates the first arm 13A and the second arm 13B forward (Step S103), and acquires the rotation angle value detected by the rotation sensor E (refer to FIG. 5) (Step S104C).

Next, the control device 14 determines whether the difference between the rotation angle instruction value outputted to the drive motor and the rotation angle value acquired at Step S104C is larger than the given preset first value (Step S105C). The given first value may be set arbitrarily to a value larger than the difference when the first arm 13A and the second arm 13B operate without load (in a state where the first arm 13A and the second arm 13B are not in contact with the principal surface of the sheet member 102 etc.), or may be the maximum value of the difference when the first arm 13A and the second arm 13B operate without load. The given first value may be, for example, zero.

If the control device 14 determines that the difference between the rotation angle instruction value outputted to the drive motor and the rotation angle value acquired at Step S104C is below the given first value (No at Step S104C), it returns to Step S103, and repeats Steps S103 to S105C until the difference between the rotation angle instruction value outputted to the drive motor and the rotation angle value acquired at Step S104C becomes larger than the given first value.

On the other hand, if the control device 14 determines that the difference between the rotation angle instruction value which outputted to the drive motor and the rotation angle value acquired at Step S104C is larger than the given first value (Yes at Step S105C), it can determine that the suction pad 92A and the suction pad 92B contact the principal surface of the sheet member 102, and the sheet member 102 is sucked by the suction pad 92A and the suction pad 92B, and then transits to the processing at Step S106.

Below, the control device 14 executes the processing at Steps S106-S110, similar to the transferring system 100 according to Embodiment 1.

The transferring system 100 according to Embodiment 4 configured in this way also has similar operation and effects to the transferring system 100 according to Embodiment 1.

### Embodiment 5

In the transferring system according to any one of Embodiments 1 to 4, a robot of the transferring system according to Embodiment 5 further includes a drive motor which relatively drives two link members connected through a joint, and a current detector which detects a current value for controlling rotation of the drive motor, and a control device is configured to operate the arm toward the principal surface of the sheet member, until the difference between the current instruction value to the drive motor and the current value detected by the current detector becomes larger than a given preset second value.

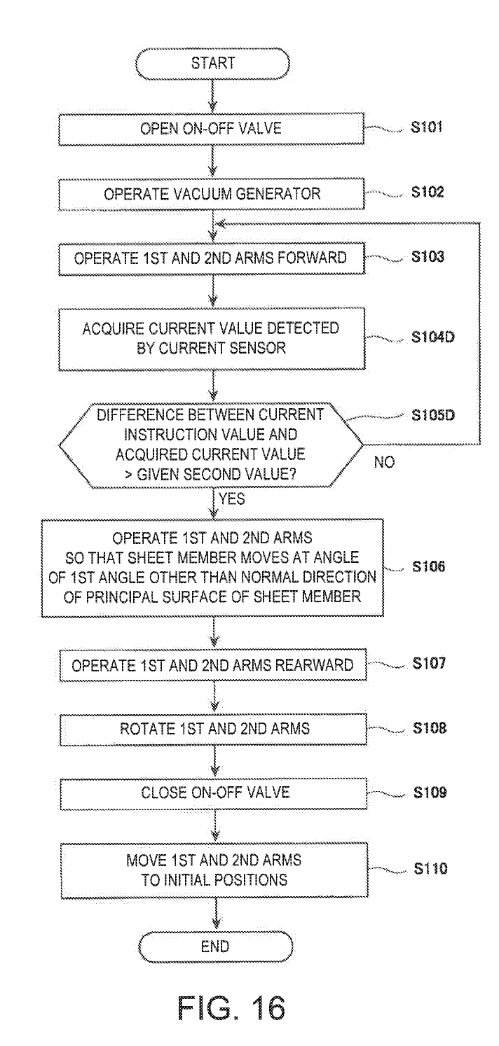

Hereinafter, one example of the transferring system according to Embodiment 5 is described with reference to FIG. 16. Note that, since the transferring system 100 according to Embodiment 5 is configured similarly to the transferring system 100 according to Embodiment 4, the detailed description is omitted.

### [Operation and Effects of Transferring System]

FIG. 16 is a flowchart illustrating one example of operation of the transferring system according to Embodiment 5. Note that the following operation is performed by the processor 14a of the control device 14 reading the program stored in the memory 14b.

As illustrated in FIG. 16, although the operation of the transferring system 100 according to Embodiment 5 is fundamentally the same as the operation of the transferring system 100 according to Embodiment 1, it differs in that Steps S104D and S105D are executed, instead of Steps S104 and S105.

Specifically, the control device 14 operates the first arm 13A and the second arm 13B forward (Step S103), and acquires the current value detected by the current sensor C (refer to FIG. 5) (Step S104D).

Next, the control device 14 determines whether the difference between the current instruction value outputted to the drive motor and the current value acquired at Step S104D is larger than the given preset second value (Step S105D). The given second value may be set arbitrarily to a value larger than the difference when the first arm 13A and the second arm 13B operate without load (in the state where the first arm 13A and the second arm 13B are not in contact with the principal surface of the sheet member 102 etc.), or may be the maximum value of the difference when the first arm 13A and the second arm 13B operates without load. The given second value may be, for example, zero.

If the control device 14 determines that the difference between the current instruction value outputted to the drive motor and the current value acquired at Step S104D is below the given second value (No at Step S104D), it returns to Step S103, and repeats Steps S103-S105D until the difference between the current instruction value outputted to the drive motor and the current value acquired at Step S104D becomes larger than the given second value.

On the other hand, if the control device 14 determines that the difference between the current instruction value outputted to the drive motor and the current value acquired at Step S104D is larger than the given second value (Yes at Step S105D), it can determine that the suction pad 92A and the suction pad 92B contact the principal surface of the sheet member 102, and the sheet member 102 is sucked by the suction pad 92A and the suction pad 92B, and transits to the processing at Step S106.

Subsequently, the control device 14 executes the processing at Steps S106-S110, similar to the transferring system 100 according to Embodiment 1.

The transferring system 100 according to Embodiment 5 configured in this way also has similar operation and effects to the transferring system 100 according to Embodiment 1.

It is apparent for a person skilled in the art that many improvements or other embodiments of the present disclosure are possible from the above description. Therefore, the above description is to be interpreted only as illustration, and it is provided in order to teach a person skilled in the art the best mode that implements the present disclosure. The details of the structures and/or the functions may be changed substantially, without departing from the spirit of the present disclosure.

### INDUSTRIAL APPLICABILITY

Since the transferring system of the present disclosure and the method of operating the same can easily transfer the sheet member one by one from the container where the plurality of sheet members are laminated in the vertically-oriented fashion, they are useful in the field of industrial robots.

### DESCRIPTION OF REFERENCE CHARACTERS

5a First Link Member
5b Second Link Member
12 Carrier
13A First Arm
13B Second Arm
14 Control Device
14a Processor
14b Memory
14c Servo Controller
15A First Arm Part
15B Second Arm Part
16 Base Shaft
17A First Wrist Part
17B Second Wrist Part
18A First Hand Part
18B Second Hand Part
20A First Attaching Part
20B Second Attaching Part
25 Vacuum Generator
42b Subtractor
42c Position Controller
42d Differentiator
42e Subtractor
42f Controller
42g Subtractor
60A Horizontal Surface
70A Stationary Part
80A Main Body
81A First Portion
82A Second Portion
82B Second Portion
90A First Suction Part
90B Second Suction Part
91A Opening
92A Suction Pad
92B Suction Pad
93A First Piping
94A Pressure Detector
100 Transferring System
101 Robot
102 Sheet Member
102A Sheet Member
103 Container
103A Residual Quantity Sensor
104 Placing Device
104a Arm Part
104b Holding Part
105 Belt Conveyor
106 Contact Detector
A Normal Direction
C Current Sensor
E Rotation Sensor
J1 Rotary Joint
J2 Rotary Joint
J3 Linear-motion Joint
J4 Rotary Joint
JT Joint
JT1 First Joint
JT4 Fourth Joint
L1 Rotation Axis
L2 Rotation Axis
L3 Rotation Axis
M Drive Motor

1. A transferring system, comprising:
a container where a plurality of sheet members are placed in a vertically-oriented fashion so that principal surfaces of the sheet members are inclined;
a robot including an arm having a plurality of joints and a suction part; and
a control device, the control device being configured to cause the suction part of the arm to suck the principal surface of the sheet member, and then operate the arm to move the sheet member in a direction at an angle of elevation other than a normal direction of the principal surface of the sheet member.

2. The transferring system of claim 1, wherein the suction part is provided with a pressure detector, and
wherein the control device is configured to operate the arm toward the principal surface of the sheet member until a pressure detected by the pressure detector becomes below a preset first pressure value.

3. The transferring system of claim 1, wherein the container is provided with a residual quantity detector configured to detect a residual quantity of the sheet members, and
wherein the control device is configured to set an operating amount to operate the arm toward the principal surface of the sheet member, based on the residual quantity of the sheet members detected by the residual quantity detector.

4. The transferring system of claim 1, wherein the arm is provided with a contact detector, and
wherein the control device is configured to operate the arm toward the principal surface of the sheet member until the contact detector detects a contact with the principal surface of the sheet member.

5. The transferring system of claim 1, wherein the robot further includes a drive motor configured to relatively drive two link members connected with each other through a joint, and a rotation detector configured to detect a rotation angle of the drive motor, and
wherein the control device is configured to operate the arm toward the principal surface of the sheet member until a difference between a rotation angle instruction value to the drive motor and the rotation angle value detected by the rotation detector becomes larger than a given preset first value.

6. The transferring system of claim 1, wherein the robot further includes a drive motor configured to relatively drive two link members connected with each other through a joint, and a current detector configured to detect a current value for controlling rotation of the drive motor, and
wherein the control device is configured to operate the arm toward the principal surface of the sheet member until a difference between a current instruction value to the drive motor and the current value detected by the current detector becomes larger than a given preset second value.

7. The transferring system of claim 1, wherein the control device is configured to operate the arm so that the sheet member moves upwardly in the vertical direction, after causing the suction part of the arm to suck the principal surface of the sheet member.

8. The transferring system of claim 1, wherein the robot includes a first arm having a first suction part, and a second arm having a second suction part.

9. A method of operating a transferring system provided with a container configured to accommodate sheet members in a vertically-oriented fashion so that principal surfaces of the sheet members are inclined, and a robot including an arm having a suction part, the method comprising the steps of:
(A) operating the arm toward the principal surface of the sheet member;
(B) causing the suction part of the arm to suck the principal surface of the sheet member after (A); and
(C) operating the arm to move the sheet member in a direction that is a direction at an angle of elevation, of a first angle that is an angle formed by a horizontal surface and the principal surface of the sheet member, other than a normal direction of the principal surface of the sheet member, after (B).

10. The method of claim 9, wherein the suction part is provided with a pressure detector, and
wherein (A) includes operating the arm toward the principal surface of the sheet member until a pressure value detected by the pressure detector becomes below a preset first pressure value.

11. The method of claim 9, wherein the container is provided with a residual quantity detector configured to detect a residual quantity of the sheet members, and
wherein (B) includes:
(B1) setting an operating amount to operate the arm toward the principal surface of the sheet member, based on the residual quantity of the sheet members detected by the residual quantity detector; and
(B2) operating the arm toward the principal surface of the sheet member based on the operating amount set in (B1).

12. The method of claim 9, wherein the arm is provided with a contact detector, and
wherein (A) includes operating the arm toward the principal surface of the sheet member until the contact detector detects a contact with the principal surface of the sheet member.

13. The method of claim 9, wherein the robot further includes a drive motor configured to relatively drive two link members connected with each other through a joint, and a rotation detector configured to detect a rotational position of the drive motor, and
wherein (A) includes operating the arm toward the principal surface of the sheet member until a difference between an instruction value to the drive motor and a detection value detected by the rotation detector becomes larger than a given preset first value.

14. The method of claim 9, wherein the robot further includes a drive motor configured to relatively drive two link members connected with each other through a joint, and a current detector configured to detect a current value for controlling rotation of the drive motor, and
wherein (A) includes operating the arm toward the principal surface of the sheet member until a difference between an instruction value to the drive motor and a detection value detected by the current detector becomes larger than a given preset second value.

15. The method of claim 9, wherein (C) includes operating the arm so that the sheet member moves upwardly in the vertical direction.

16. The method of claim 9, wherein the robot includes a first arm having a first suction part, and a second arm having a second suction part.
